(19) United States
(12) Patent Application Publication
(10) Pub. No.: US 2022/0187142 A1
(43) Pub. Date: Jun. 16, 2022

(54) METHOD FOR MAINTAINING AN ELECTRICAL COMPONENT

(71) Applicant: SIEMENS ENERGY GLOBAL GMBH & CO. KG, München (DE)

(72) Inventors: Christoph Armschat, Erlangen (DE); Markus Distler, Effeltrich (DE); Joerg Hafermaas, Erlangen (DE); Nicolas Soellner, Erlangen (DE); Anna Soergel, Nuernberg (DE); Uwe Weigt, Erlangen (DE); German Kuhn, Erlangen (DE)

(21) Appl. No.: 17/599,012

(22) PCT Filed: Mar. 28, 2019
(86) PCT No.: PCT/EP2019/057816

§ 371 Date: Sep. 28, 2021

(51) Int. Cl. G01K 7/16; G01K 15/00

(52) U.S. Cl. CPC G01K 7/16; G01K 15/005

(57) ABSTRACT

A method for maintaining a first electrical component includes the following: Temperature measurement values recorded at the first electrical component are stored as a first set of measurement data, and temperature measurement values recorded at least at one second and one third electrical component are stored as second and third sets of measurement data. Taking into account the three sets of measurement data, a verification is carried out to determine whether a maintenance operation is necessary at the first component. There is also described a data-processing system for carrying out the method.

The invention relates to a method for maintaining a first electrical component.

An electrical component of this type can be a component of a high-voltage direct current transmission system, a switching system, a surge arrester, a transformer or the like, for example. Further examples are capacitors of a capacitor bank or devices which are installed in three-phase networks as three single-phase individual devices, such as chokes, filter resistors or air-insulated switches, for example. Components of this type, in particular high-voltage or medium voltage components, only fail very rarely. However, one individual component error can result in the entire system failing, the functional part of which is the electrical component.

Suitable electrical components have a permissible temperature range during operation. If the components are operated outside the permissible temperature range, the lifetime consumption and the risk of failure increases significantly. In order to ensure that the temperature range is observed, the components are usually designed or manufactured with suitable reserves. The risk of a component overload is reduced considerably as a result of this oversizing of the components, but it is not completely ruled out. In addition, the manufacturing costs correspondingly increase.

The object of the invention is to propose a method mentioned at the outset which makes it possible to operate the electrical component in a manner which is as efficient and reliable as possible.

The object is achieved according to the invention by a method for maintaining a first electrical component in which temperature measurement values recorded at the first electrical component are stored as first measurement data, temperature measurement values recorded at least at one second and one third electrical component are stored as second and third measurement data and, taking into account the three measurement data, it is checked whether a maintenance operation and/or a control measure is necessary at the first component. Temperature measurement values which are recorded at the electrical components form the basis of maintenance. The temperature measurement values can derive from one or a plurality of temperature sensors which are arranged at one or a plurality of locations of the respective component. The temperature sensors are suitably set up to be used on components, optionally also at high voltage potential, to transmit the recorded temperature measurement values in a wireless manner, suitably via radio. The received data are stored accordingly. The sensors can be arranged on the surface of the relevant component, for example, so that it measures a surface temperature. However, it is also conceivable that a temperature is recorded inside the respective component by means of the sensor or sensors. For example, the temperature of an inner conductor of the component can be recorded, wherein the inner conductor is surrounded on the outside by an outer insulator. When applied at high voltage potential, the sensor can be protected against damage by a protective circuit. This is particularly useful when using sensors which are connected to an external sensor node. In the simplest case, this can take place by way of a z diode or a low-pass filter. When positioning the sensor system, possible electrical or electromagnetic effects must be considered in order to prevent disturbance of the sensor system or any influence on the systems. For this purpose, electrical, magnetic and electromagnetic emissions must be limited. This can be achieved by means of the following measures (individually or in any combination): positioning the sensor nodes in the field shadow, for example in the field shadow of a corona ring, positioning in strong alternating magnetic fields in the protection of a magnetic shield plate, positioning with only a slight surface change in the electrostatic field, optionally using a passively controlled surface contour with suitably set permittivity, positioning in particularly high-frequency electromagnetic fields. Within the context of the invention, the temperature measurement values can be specified by direct measurements or also by temporally or spatially averaged measurement data, for example. An averaging of this type has the advantage of a smaller amount of transmitted data. Accordingly, it is also conceivable to advantageously select the transmitted temperature measurement values, in any case before they are stored, for the measurement data in a different manner, in order to reduce the amount of data. The measurement data are suitably successively stored in a temporal arrangement of individual measurement data points (tuples of a respective measurement data point and a time indication are also conceivable) in a storage medium of a data processing system (or distributed over a plurality of data processing systems). One essential advantage of the invention is the use of the temperature measurement values for maintaining the first electrical component (in particular through comparison with the remaining components, whereby outliers can be identified, for example). This makes it possible to avoid complex manual measurements and evaluation on site, which enables particularly efficient maintenance. In addition, the evaluation of the measurement data can take place continuously, whereby suitable maintenance and preservation measures can take place at any time. This increases the reliability of the first electrical component during operation. Moreover, the method can be carried out accordingly with respect to the at least three electrical components. The number of components is, of course, not limited to three.

In order to check whether a maintenance operation is necessary at the first component, the measurement data of at least one second and one third electrical component (advantageously components of the same type) are also taken into account according to the invention. The underlying knowledge of the invention is therefore that monitoring merely one electrical component only allows reliable maintenance to a limited extent. The reason for this is that in particular long-term changes to the environment and to the entire system influence the measurements and require adjustments to any operating points and operating ranges which are not or barely identifiable in the case of measurements at an individual component. By contrast, the use or consideration of three or more components, for example but not necessarily of one and the same high-voltage or medium-voltage system, enables a reliable identification of maintenance requirements or errors in the first component (or even all components considered). In this case, the at least three electrical components can advantageously be components of a so called cluster, such as capacitors of a capacitor bank, power modules of a modular power converter, arrester housings of an arrester bank or the like, for example. The advantage of this is that the environmental conditions for all components are comparable and therefore can be factored out or disregarded in a suitable manner.

Aside from a maintenance operation, a control measure may be identified as necessary or desired. One possible control measure may be activation of the component for an overload operation in the case of a low component temperature, for example. Alternatively, it is also conceivable to lower the highest permissible operating temperature, for example.

According to one embodiment of the invention, the measurement data are compared with one another and checking takes place taking into account measurement data differences. The measurement data differences can be determined as differences in the measurement data relative to one another or to a specified or determined value, for example a mean value. Individual measurement data points are suitably compared with one another which correspond to measurements recorded at the same time (or measurement data points which correspond to measurement values recorded at different times, but wherein the time differences are not greater than a predetermined differential time). The consideration of the measurement data differences enables a simple and effective identification of noticeable changes in the temperatures of the components relative to one another or among one another.

A measurement data mean value and a first measurement data difference between the first measurement data (the measurement data values) and the measurement data mean value are preferably formed, wherein checking comprises a comparison of the first measurement data difference with a difference threshold value. The measurement data mean value therefore forms a further time sequence, since the mean values corresponding to the temporal arrangement are calculated from the respective measurement data of the at least three components. If the difference threshold value is exceeded, a change in the operating characteristics of the component of a cluster or an error condition can be inferred. In many cases, in particular in the case of components which are the same and sensors which are installed in the same manner, which supply the measurement data, a comparative measurement is sufficient in order to discover irregularities. The outlier is identified and, in the case of a short interruption of operation, the component may optionally be controlled in a targeted manner on site. In this case, the accuracy of the individual measurement takes a back seat.

According to one embodiment of the invention, checking comprises forming a temperature change from the first measurement data. It is possible to carry out a more accurate assessment of irregularities in the first component by observing the temperature increase or decrease. An evaluation of the trend behavior of the measurement data can be particularly advantageous.

Checking preferably comprises a comparison of the temperature increase with a reference temperature increase (i.e. a typical time constant of the component, environmental conditions included or taken into account). In this way, long-term changes can advantageously be taken into account for the evaluation.

It is considered advantageous if checking comprises a comparison of the first measurement data with environmental temperature measurement data recorded at the first component. For example, a surface temperature can be compared with an associated environmental temperature. Depending on how high the surface temperature is and how great the difference compared to the environmental temperature, different measures may be useful or a further analysis of the measurement data may take place. Moreover, a calibration can be carried out in such a way that temperature measurements at different environmental temperatures are carried out in a test field. The characteristics acquired in this manner are stored and are taken into account when analyzing the measurement data.

Checking is preferably carried out taking into account operating data of the electrical component. In particular, the operating data can be current and voltage (a current which flows through the component, a voltage which drops at the component). This makes it possible to obtain an even more accurate picture of the load state of the component.

Checking can be carried out taking into account a calibration of the temperature measurement. Provided that this seems advantageous, a calibration can be carried out in a test field in this case. The different methods, if applicable, for determining the temperature can be measured in the test field with a certain number of operating states. Correction curves can thereby be established from a variable which is to be measured, measured value and influencing environmental parameters (e.g. ambient air, the temperature thereof, humidity, etc.). These correction curves are then also stored and are taken into account when evaluating the measurement data. This makes it possible to achieve a particularly high level of accuracy and reliability for the method.

Suitably, it is possible to check whether the measurement data or a variable derived therefrom meet a plurality of predetermined conditions, wherein a separate maintenance instruction or control measure is allocated to each condition and is triggered if the allocated condition is present. A plurality of conditions are therefore defined, wherein each of the conditions is allocated to its own maintenance instruction. The fulfillment of a first condition can be linked to the maintenance instruction to place the component under special observation, for example, a second condition can be linked to the maintenance instruction to clean the component or the outer insulator, a third condition can be linked to the maintenance instruction to replace the component, etc.

The invention further relates to a data processing system.

The object of the invention is to propose a data processing system, by means of which an efficient maintenance of an electrical component is made possible.

The object is achieved according to the invention by a data processing system which is set up to carry out a method according to the invention.

The advantages of the data processing system according to the invention emerge in particular from the advantages which have already been explained in connection with the method according to the invention.

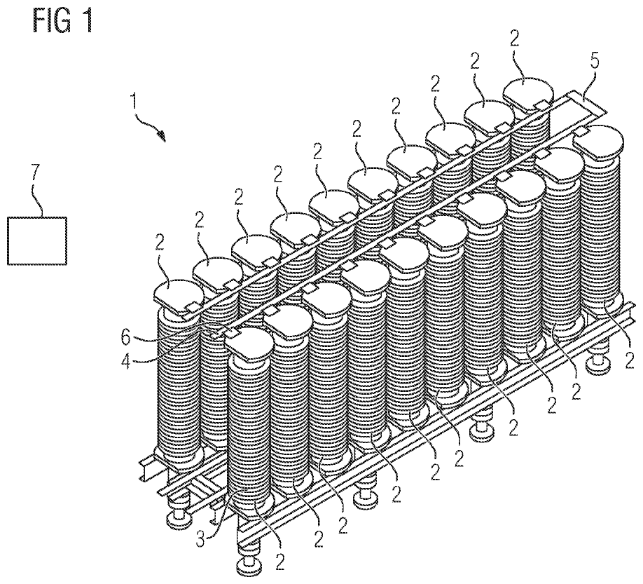

The invention is explained in more detail hereinafter using exemplary embodiments which are represented in FIGS. 1 to 3.

FIG. 1 shows an example of electrical components which are suitable for maintenance by means of the method according to the invention;

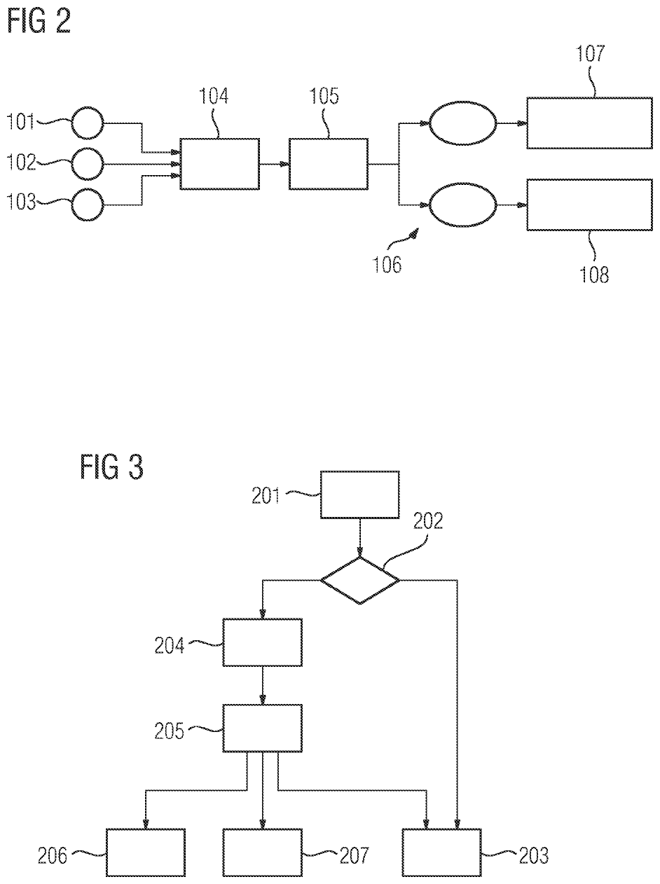

FIG. 2 shows a first exemplary embodiment of a method according to the invention;

FIG. 3 shows a second exemplary embodiment of the method according to the invention.

FIG. 1 represents an arrester bank 1 with twenty identical surge arresters 2. Each surge arrester comprises an outer insulator 3 as well as a high-voltage terminal 4 for connection to a high-voltage line 5. At the high-voltage terminal 4, temperature is measured at each surge arrester by means of its own sensor 6 placed there and is sent as measurement data to an evaluation unit in the form of a data processing system 7. Comparing the measurement data makes it possible to check whether the surface temperature of one of the surge arresters deviates from the rest and therefore a maintenance operation may be necessary.

FIG. 2 is a schematic representation of the course of an evaluation of the measurement data which have been transmitted from three electrical components. In a first method step 101, first measurement data Th1 of a temperature sensor of a first component are stored (as a data series Th1(t)). Correspondingly, second and third measurement data Th2 or Th3 of one second and one third component are stored in two method steps 102 and 103 which are performed simultaneously or consecutively, for example. In a fourth method step 104, a mean value ThM(t) is formed as ⅓ *(Th1(t)+Th2(t)+Th3(t)). In a fifth method step 105, a first measurement data difference DeltaTh1(t)=Th1(t)−ThM(t) is calculated. In the following, two cases are distinguished: if a check 106 shows that the first measurement data difference reaches or exceeds a predetermined difference threshold value x, a maintenance instruction is output or the measurement data are analyzed more closely in a seventh method step 107. If the check 106 shows that the measurement data difference is below the difference threshold value, information is displayed that the first component does not require any maintenance measures in an eighth method step 108.

One further possibility of the evaluation is represented schematically in FIG. 3. In a first method step 201, measurement data which is transmitted from a sensor of a first electrical component, in particular a measurement data point Th is stored in a storage device of a data processing system. In a second method step 202, it is checked whether the measurement data point value reaches or exceeds a maximum temperature Tmax. If this is the case, further analysis of the measurement data is carried out in a third method step 203. If this is not the case, an absolute difference dTh between the measurement data point and an outside temperature Ta measured at the component and transmitted is formed in a fourth method step 204: dTh=|Th−Ta|. In a fifth method step, it is checked whether the absolute difference dTh is below a lower limit value T1, is equal to the or above an upper limit value T2 or is between the lower and upper limit value T1<=dTh<T2. If dTh>=T2, further analysis is carried out in method step 203, in order to examine the case more closely and, if applicable, the measures that should be taken. If dTh<T1, information is provided in a sixth method step 206 that a higher capacity utilization is possible for the first component or the system in which the component is used. If T1<=dTh<T2, information is provided in a seventh method step 207 that the component can be operated in nominal load operation.

With the arrangement of the temperature sensor directly on the active part of the component, one further conceivable variant is provided. Depending on the application, more accurate information regarding the state of the component can be achieved if the temperature sensor is installed at the hot point of the active part of the component. In this case, the comparative method described above can be applied in order to identify an impending error, despite the fact that the component operating at partial load has not (yet) reached the maximum permissible temperature limits, for example.

The two approaches from FIGS. 2 and 3 are not necessarily alternative and can be executed in combination within the context of the invention.

1-10. (canceled)

11. A method for maintaining a first electrical component, the method comprising:
storing temperature measurement values recorded at the first electrical component as first measurement data;
storing temperature measurement values recorded at a second electrical component and at a third electrical component as second and third measurement data, respectively;
checking whether a maintenance operation and/or a control measure is necessary at the first component taking into account the first, second, and third measurement data.

12. The method according to claim 11, wherein the checking step comprises comparing the measurement data with one another and taking into account differences between the measurement data.

13. The method according to claim 12, which comprises forming a measurement data mean value and forming a first measurement data difference between the first measurement data and the measurement data mean value, and, in the checking step, comparing the first measurement data difference with a difference threshold value.

14. The method according to claim 11, wherein the checking step comprises forming a temperature change from the first measurement data.

15. The method according to claim 14, wherein the checking step comprises comparing a temperature increase with a reference temperature increase.

16. The method according to claim 11, wherein the checking step comprises comparing the first measurement data with environmental temperature measurement data recorded at the first component.

17. The method according to claim 11, wherein the checking step comprises taking into account operating data of the electrical component.

18. The method according to claim 11, wherein the checking step comprises taking into account a calibration of the temperature measurement.

19. The method according to claim 11, wherein the checking step comprises checking whether the measurement data or a variable derived therefrom meet a plurality of predetermined conditions, wherein a separate maintenance instruction is assigned to each condition, and the maintenance instruction is triggered if the allocated condition is present.

20. A data processing system configured to carry out the method according to claim 11.
